(19) United States
(12) Patent Application Publication
(10) Pub. No.: US 2026/0231071 A1
(43) Pub. Date: Aug. 6, 2026

(54) TRIGGER-BASED WIRELESS TRANSMISSION ADJUSTED FOR PROPAGATION DELAY

(71) Applicant: QUALCOMM Incorporated, San Diego, CA (US)

(72) Inventors: Abhijit BHATTACHARYA, Bangalore, Karnataka (IN); Vinod BELUR RAMACHANDRA, Chennai, Tamil Nadu (IN); Suresh CHANDRASEKARAN, Chennai, Tamil Nadu (IN); Arul Durai Murugan PALANIVELU, Bangalore, Karnataka (IN); Xiaolong HUANG, Santee, CA (US)

(21) Appl. No.: 19/146,191

(22) PCT Filed: Feb. 14, 2024
(86) PCT No.: PCT/US2024/015851

§ 371 Date: Jul. 7, 2025

(30) Foreign Application Priority Data
Mar. 11, 2023 (IN) 202341016353

(51) Int. Cl. H04W 56/00

(52) U.S. Cl. CPC H04W 56/0045

(57) ABSTRACT

This disclosure provides methods, components, devices and systems for wireless local area network (WLAN) communications in consideration of propagation delay between wireless communication devices. Some aspects more specifically relate to trigger-based uplink transmission adjusted for propagation delay between a wireless station (STA) a wireless access point (AP). The STA can receive a trigger frame that includes an indication of the propagation delay or can estimate the propagation delay. Responsive to the trigger frame, the STA may adjust a transmit time of an uplink communication according to a target start time for receipt of the communication by the AP. In some examples, the AP can account for the propagation delay by adjusting the target start time for receipt of the communication by the AP or by grouping multiple STAs into a group for a multi-user transmission in accordance with there being a variation of propagation delays that is within a threshold.

### CROSS-REFERENCE TO RELATED APPLICATIONS

This application claims the benefit of Indian Provisional Application Number 202341016353 titled “TRIGGER-BASED WIRELESS TRANSMISSION ADJUSTED FOR PROPAGATION DELAY,” filed January Mar. 11, 2023, which is assigned to the assignee hereof, and incorporated herein by reference in its entirety.

### TECHNICAL FIELD

This disclosure relates generally to wireless communication, and more specifically, to trigger-based transmission adjusted for a propagation delay between wireless communication devices.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, the STAs and/or APs can communicate using long-range WiFi techniques, such as for applications including surveillance drones, which may communicate with a central controller AP over distances up to several kilometers, and industrial internet-of-things (IoT) applications, such as factory environments, or other applications. In some WLANs, the STAs and APs can communicate using multi-user techniques such as orthogonal frequency division multiple access (OFDMA) and/or multi-user multiple-input multiple-output (MU-MIMO) that facilitate trigger-based uplink transmissions, which can provide improved scheduling control via a central controller AP, higher data rates, reduced collision overhead improved communication range, and/or other benefits.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes at least one memory, and at least one processor communicatively coupled with the at least one memory. The at least one processor is operable to cause the wireless communication device to receive, from a wireless access point, an indication associated with a propagation delay between the wireless access point and the wireless communication device, receive, from the wireless access point, a trigger frame configured to trigger a transmission of a communication by the wireless communication device, and transmit, to the wireless access point in response to the trigger frame, the communication at a time corresponding to a target start time of receipt of the communication by the wireless access point adjusted in accordance with the indication of the propagation delay, the target start time of receipt of the communication being later than a short interframe space (SIFS) duration after an end time of transmission of the trigger frame by the wireless access point.

Another innovative aspect of the subject matter described in this disclosure can be implemented in a wireless communication device. The wireless communication device includes at least one memory, and at least one processor communicatively coupled with the at least one memory. The at least one processor is operable to cause the wireless communication device to transmit, to a wireless station, an indication associated with a propagation delay between the wireless communication device and the wireless station, transmit, to the wireless station, a trigger frame configured to trigger a transmission of a communication by the wireless station, and receive, from the wireless station in response to the trigger frame, the communication at a time corresponding to a target start time of receipt of the communication by the wireless communication device adjusted in accordance with the propagation delay, the target start time of receipt of the communication being later than a SIFS duration after an end time of transmission of the trigger frame by the wireless communication device.

Another innovative aspect of the subject matter described in this disclosure can be implemented in a method for wireless communication. The method includes receiving, from a wireless access point, an indication associated with a propagation delay between the wireless access point and the wireless station, receiving, from the wireless access point, a trigger frame configured to trigger a transmission of a communication by the wireless station, and transmitting, to the wireless access point in response to the trigger frame, the communication at a time corresponding to a target start time of receipt of the communication by the wireless access point adjusted in accordance with the indication of the propagation delay, the target start time of receipt of the communication being later than a SIFS duration after an end time of transmission of the trigger frame by the wireless access point.

Another innovative aspect of the subject matter described in this disclosure can be implemented in a method for wireless communication. The method includes transmitting, to a wireless station, an indication associated with a propagation delay between the wireless access point and the wireless station, transmitting, to the wireless station, a trigger frame configured to trigger a transmission of a communication by the wireless station, and receiving, from the wireless station in response to the trigger frame, the communication at a time corresponding to a target start time of receipt of the communication by the wireless access point adjusted in accordance with the propagation delay, the target start time of receipt of the communication being later than a SIFS duration after an end time of transmission of the trigger frame by the wireless access point.

In some examples, the methods and wireless communication devices may receive, from a wireless access point, an indication associated with a propagation delay between the wireless access point and the wireless communication device, receive, from the wireless access point, a trigger frame configured to trigger a transmission of a communication by the wireless communication device, and transmit, to the wireless access point in response to the trigger frame, the communication at a time corresponding to a target start time of receipt of the communication by the wireless access point adjusted in accordance with the indication of the propagation delay, the target start time of receipt of the communication being later than a short interframe space (SIFS) duration after an end time of transmission of the trigger frame by the wireless access point.

In some examples of the methods and wireless communication devices may transmit, to a wireless station, an indication associated with a propagation delay between the wireless communication device and the wireless station, transmit, to the wireless station, a trigger frame configured to trigger a transmission of a communication by the wireless station, and receive, from the wireless station in response to the trigger frame, the communication at a time corresponding to a target start time of receipt of the communication by the wireless communication device adjusted in accordance with the propagation delay, the target start time of receipt of the communication being later than a short interframe space (SIFS) duration after an end time of transmission of the trigger frame by the wireless communication device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network according to some aspects of the present disclosure.

FIG. 2 shows a pictorial diagram of another example wireless communication network according to some aspects of the present disclosure.

FIG. 3 shows a flowchart illustrating an example process performable by a wireless STA that supports trigger-based uplink transmission adjusted for a propagation delay between the STA and an access point (AP) according to some aspects of the present disclosure.

FIG. 4 shows a flowchart illustrating an example process performable by a wireless AP that supports trigger-based uplink transmissions adjusted for a propagation delay between a STA and the AP according to some aspects of the present disclosure.

FIG. 5 shows an example timeline of communications between an AP and two STAs in consideration of a propagation delay between the AP and each STA according to some aspects of the present disclosure.

FIG. 6 shows a flowchart illustrating an example process performable at an AP that supports grouping multiple STAs for communicating with the AP in consideration of propagation delays between the AP and the STAs according to some aspects of the present disclosure.

FIG. 7 shows a flowchart illustrating an example process performable at an AP that supports scheduling multiple groups of wireless STAs for communicating with the AP in consideration of propagation delays between the AP and the STAs according to some aspects of the present disclosure.

FIG. 8 shows an example timeline of communications between an AP and two wireless STAs by which the AP can group the STAs according to propagation delays between the AP and the STAs according to some aspects of the present disclosure.

FIG. 9 shows a flowchart illustrating an example process performable at a STA that supports trigger-based uplink transmissions adjusted for a propagation delay between the STA and an AP according to some aspects of the present disclosure.

FIG. 10 shows a flowchart illustrating an example process performable at an AP that supports trigger-based uplink transmissions adjusted for a propagation delay between a STA and the AP according to some aspects of the present disclosure.

FIG. 11 shows an example timeline of communications between an AP and two STAs by which each of the STAs estimates a propagation delay between itself and the AP according to some aspects of the present disclosure.

FIG. 12 shows a block diagram of an example wireless communication device that supports trigger-based uplink transmissions adjusted for a propagation delay between a STA and an AP according to some aspects of the present disclosure.

FIG. 13 shows a block diagram of an example wireless communication device that supports trigger-based uplink transmissions adjusted for a propagation delay between a STA and an AP according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to WLAN communication in consideration of a propagation delay between wireless communication devices. Some aspects more specifically relate to trigger-based uplink transmission adjusted for a propagation delay between a wireless station (STA) and a wireless access point (AP). In some examples, the AP may transmit, and the STA may receive, a trigger frame that includes an indication of the propagation delay. In some other examples, the STA can itself estimate the propagation delay. Responsive to the trigger frame, and based on or otherwise associated with the propagation delay, the STA may transmit an uplink communication to the AP. The STA may adjust the transmit time of the uplink communication according to a target start time for receipt of the communication by the AP. In some examples, the target start time can be later than a short interframe space (SIFS) duration after an end time of the transmission of the trigger frame by the AP. Similarly, the AP can adjust the target start time for receipt of the communication by the AP to account for the propagation delay, such as based on a minimum propagation delay of STAs scheduled by the AP. In some examples, the AP can group multiple STAs into a group for a multi-user transmission (for example, an OFDMA or MU-MIMO transmission) in accordance with there being a variation of propagation delays between the AP and STAs in the group that is within a threshold.

Particular aspects of the subject matter described in this disclosure can be implemented to realize one or more of the following potential advantages. In some examples, by considering the propagation delay in adjusting a time for transmitting WLAN communications or in adjusting a target start time for receiving the WLAN communications, the AP can use or set a same target start time for receiving communications from multiple STAs, as the propagation delays among the STAs can be within a threshold. In some examples, the AP can configure the SIFS duration for certain STAs to account for a propagation delay that is larger than a threshold. The described techniques can be used to enable OFDMA and/or multi-user multiple-input multiple-output (MU-MIMO) to be used for WLAN communications between a group of STAs and an AP having propagation delays that are larger than a threshold. For example, in using OFDMA, a STA or AP may use a fast Fourier transform (FFT) window size of a certain size and a guard interval (GI) of a certain duration, the combination of which may be shorter than the propagation delay, such as for applications in which the STA and AP are communicating using long-range WiFi. In such applications, for example, considering and/or accounting for the propagation delay by adjusting a time for the STA to transmit the WLAN communications or adjusting a target start time for the AP to receive the WLAN communications can allow OFDMA to be used even where the propagation delay is longer than the FFT window size and/or GI. This can also allow for STAs and APs communicating over a long range where the propagation delay is larger than a threshold to still use, and achieve benefits of, OFDMA and/or MU-MIMO communications, such as greater scheduling control, higher data rates, reduced collision overhead, and/or range benefits.

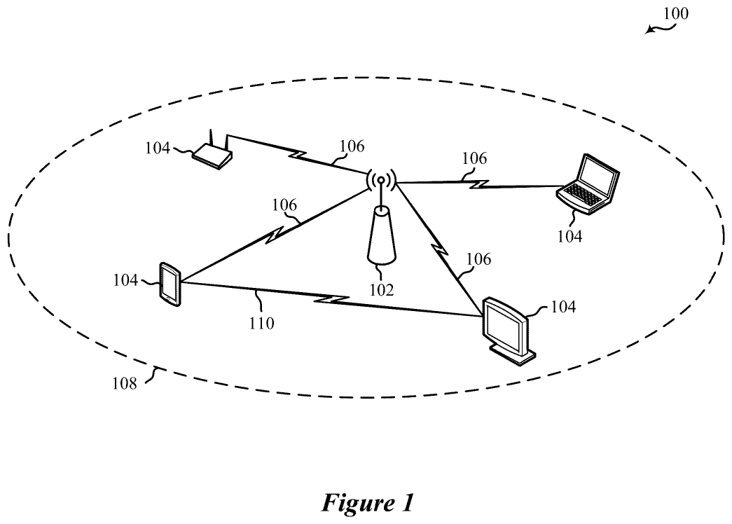

FIG. 1 shows a block diagram of an example wireless communication network 100 according to some aspects of the present disclosure. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from overlapping BSS (OBSS) interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

APs and STAs that include multiple antennas may support various diversity schemes. For example, spatial diversity may be used by one or both of a transmitting device or a receiving device to increase the robustness of a transmission. For example, to implement a transmit diversity scheme, a transmitting device may transmit the same data redundantly over two or more antennas.

APs and STAs that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are then mapped to N_{Tx} transmit chains.

APs and STAs that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are then separately encoded and transmitted in parallel via the multiple N_{Tx} transmit antennas. APs and STAs that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU multiple-input multiple-output (MIMO) (MU-MIMO) transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may then perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, power level, etc. to use to transmit a respective signal on each of the beamformer's antennas.

A transmitting device may support the use of diversity schemes. When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP's spatial multiplexing capability, an AP may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For examples, the CSI feedback overhead may be reduced using an implicit channel sounding procedure such as an implicit beamforming report (BFR) technique (such as where STAs transmit NDP sounding packets in the UL while the AP measures the channel) because no BFRs are sent. Once the AP receives the NDPs, it may implicitly assess the channels for each of the STAs and use the channel assessments to configure steering matrices. In order to mitigate hardware mismatches that could break the channel reciprocity on the UL and DL (such as the baseband-to-RF and RF-to-baseband chains not being reciprocal), the AP may implement a calibration method to compensate for the mismatch between the UL and the DL channels. For example, the AP may select a reference antenna, transmit a pilot signal from each of its antennas, and estimate baseband-to-RF gain for each of the non-reference antennas relative to the reference antenna.

In some examples, multiple APs may transmit to one or more STAs at a time utilizing a distributed MU-MIMO scheme. Examples of such distributed MU-MIMO transmissions include coordinated beamforming (CBF) and joint transmission (JT). With CBF, signals (such as data streams) for a given STA may be transmitted by only a single AP. However, the coverage areas of neighboring APs may overlap, and signals transmitted by a given AP may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP may beamform signals to in-BSS STAs while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA may be transmitted by multiple coordinated APs. For the multiple APs to concurrently transmit data to a STA, the multiple APs may all need a copy of the data to be transmitted to the STA. Accordingly, the APs may need to exchange the data among each other for transmission to a STA. With JT, the combination of antennas of the multiple APs transmitting to one or more STAs may be considered as one large antenna array (which may be represented as a virtual antenna array) used for beamforming and transmitting signals. In combination with MU-MIMO techniques, the multiple antennas of the multiple APs may be able to transmit data via multiple spatial streams. Accordingly, each STA may receive data via one or more of the multiple spatial streams.

APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP may allocate or assign multiple RUs to a single STA. As increasing bandwidth is supported by emerging standards (such as 802.11be supporting 320 MHz), various multiple RU (multi-RU) combinations may exist. Values indicating the various multi-RU combinations may be provided by a suitable standard specification (such as one or more of the IEEE 802.11 family of wireless communication protocol standards including 802.11be).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing is a wireless communication technique that enables a wireless communication device (such as an AP or a STA) to transmit and receive wireless communications over a portion of a wireless channel exclusive of one or more particular subchannels (hereinafter also referred to as “punctured subchannels”). Static puncturing specifically may be used to exclude one or more subchannels from the transmission of a PPDU, including the signaling of the preamble, to avoid interference from a static source such as an incumbent system. The transmitting device may puncture the subchannels on which there is interference and in essence spread the PPDU to cover the remaining portion of the bandwidth of the channel. For example, if a wireless communication device determines (for example, detects, identifies, ascertains, or calculates) that a 20 MHz subchannel of a 160 MHz or 320 MHz wireless channel is consistently occupied, the wireless communication device can use channel puncturing to avoid communicating over the occupied subchannel while still utilizing the remaining 140 MHz or 300 MHz of bandwidth. Accordingly, channel puncturing allows a wireless communication device to improve or maximize its throughput by utilizing more of the available spectrum that would otherwise have been idle. Static puncturing in particular makes it possible to consistently use wide channels in environments where there is insufficient contiguous spectrum available. Additionally, puncturing also may be used in conjunction with multi-RU transmissions to enable wide channels to be established using non-contiguous spectrum blocks. In such examples, the portion of the bandwidth between two RUs allocated to a particular STA may be punctured. Accordingly, spectrum efficiency and flexibility may be increased.

STA-specific RU allocation information is included in the EHT-SIG field of the PPDU's preamble. Because RUs may be individually allocated in a MU PPDU, use of the MU PPDU format may indicate preamble puncturing for SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

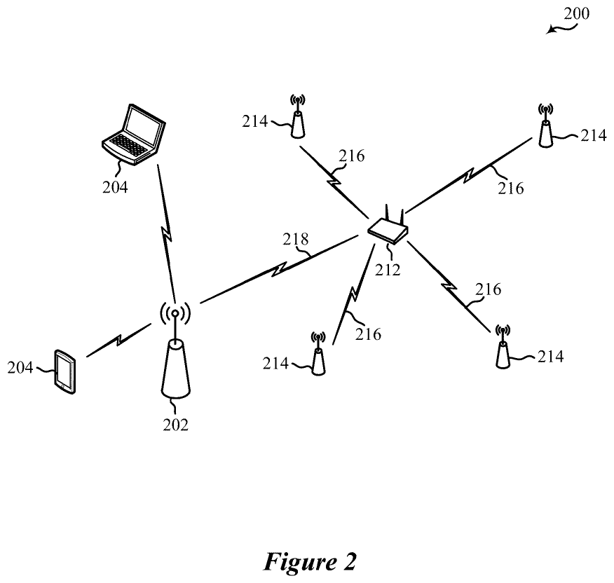

FIG. 2 shows a pictorial diagram of another example wireless communication network 200 according to some aspects of the present disclosure. According to some aspects, the wireless communication network 200 can be an example of a mesh network, an IoT network or a sensor network in accordance with one or more of the IEEE 802.11 family of wireless communication protocol standards (including the 802.11ah amendment). The wireless network 200 may include multiple wireless communication devices 214. The wireless communication devices 214 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and then transmit such raw or processed data to an intermediate device 212 for subsequent processing or distribution. Additionally or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a Wi-Fi WLAN or a wireless (for example, cellular) wide area network (WWAN), which may, in turn, provide access to external networks including the Internet. For example, the intermediate device 212 may associate and communicate, over a Wi-Fi link 218, with an AP 202 of a WLAN network, which also may serve various STAs 204. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

When an AP and a STA, or other wireless devices in a WLAN, communicate over a large distance, the propagation delay between the wireless devices can exceed a threshold (such as a FFT window size and/or GI), which can pose challenges for UL trigger-based (TB) PPDU reception. For example, when an AP sends a trigger frame at a time T to a group of STAs, the AP may expect to receive a response from each of the STAs at time T+SIFS. The responses, however, may start arriving at T+SIFS+D, where D is the round-trip propagation delay between the AP and the respective STAs. This delay can impact the FFT window in the physical layer receive path at the AP unless D≤GI.

In another example, the AP supporting MU UL TB PPDU transmissions may experience staggered start of times associated with receiving the respective trigger-based transmissions from the multiple wireless STAs due to propagation delay differences. In this example, D1 can denote the round-trip propagation delay between a first wireless STA and the AP, and D2 can denote the round-trip propagation delay between a second wireless STA and the AP. The MU UL TB PPDU transmissions from the devices can respectively arrive at the AP at T+SIFS+D1 and T+SIFS+D2, which may cause the AP to use different FFT windows for decoding the MU UL TB PPDU transmissions. This may impact preamble decoding performance and overall UL MU receive performance unless D1, D2≤GI, AND |D2−D1|≤GI.

In some examples, a largest value of a GI defined for OFDMA for WLAN communications can be 3.2 microseconds (μs), which may correspond to a range of 480 meters (m) assuming an ideal line-of-sight (LOS) scenario. In this regard, for example, using OFDMA for WLAN communications may be range-limited when certain WLAN applications use a limited GI or a limited FFT window. This limitation in range may impact DL MU data and MU sounding for WLAN communications, at least because block acknowledgements (BAs), transmission control protocol (TCP) acknowledgements (ACKs) for DL MU, and compressed beamforming feedback (CBF) report for MU Sounding, are carried in UL TB PPDU transmissions.

In another example, wireless devices communicating over a large distance in a WLAN may experience a channel sensing limitation. For example, an AP may send a trigger for a first wireless STA (STA1), such as a MAC layer trigger frame, and a second wireless STA (STA2) may start a SU PPDU transmission before receiving the trigger. In this example, the SU PPDU transmission from the STA2 may reach the STA1 after a propagation delay D3, where D3>SIFS from the end of transmission of the trigger. This may occur for a 16 ys SIFS duration if the STA1 and the STA2 are separated by more than 4.8 kilometers (Kms). Where the trigger from the AP indicates that carrier sensing (CS) is to be performed (for example, indicating a value CS required=1), the STA1, upon receiving the trigger, can perform carrier sensing up to the SIFS duration, detect a medium idle carrier, and accordingly start TB PPDU transmission. This can result in a collision at the AP between the SU PPDU transmission of the STA1 and the TB PPDU transmission of the STA2. This channel sensing limitation due to insufficient SIFS duration may also impact request-to-send (RTS)/clear-to-send (CTS) protected SU/MU transmissions. This problem may also be encountered when there are OBSS nodes separated by a propagation delay that is larger than the SIFS duration from the in-BSS nodes. Aspects described herein can resolve the foregoing potential issues of wireless devices communicating over large distances.

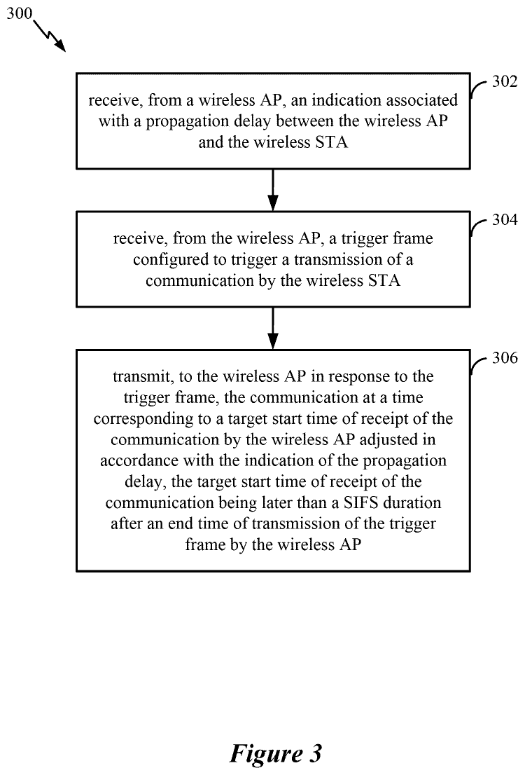

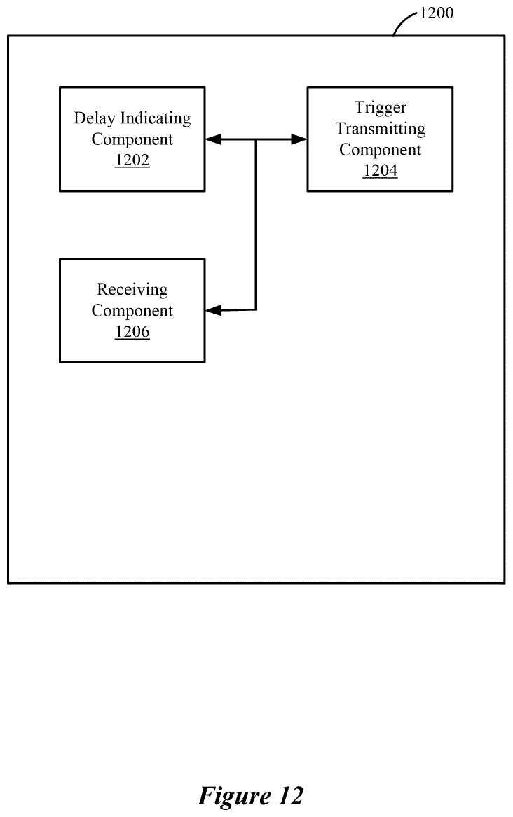

FIG. 3 shows a flowchart illustrating an example process 300 performable at a wireless STA that supports trigger-based uplink transmission adjusted for a propagation delay between the STA and an AP according to some aspects of the present disclosure. The operations of the process 300 may be implemented by a wireless STA or its components as described herein. For example, the process 300 may be performed by a wireless communication device, such as the wireless communication device 1200 described with reference to FIG. 12, operating as or within a wireless STA. In some examples, the process 300 may be performed by a wireless STA such as one of the STAs 104 described with reference to FIG. 1.

In some examples, in block 302, the wireless STA can receive, from a wireless AP, an indication associated with a propagation delay between the wireless AP and the wireless STA. For example, the wireless STA can receive the indication associated with the propagation delay as an explicit indication of the propagation delay, such as an indication of a number of milliseconds of the propagation delay. In some examples, the wireless AP can indicate the propagation delay as a round-trip propagation delay between the wireless AP and the wireless STA. For example, the wireless STA can receive the indication of the propagation delay in a configuration from the wireless AP, which may include receiving the indication in one or more fields of a trigger frame (for example, the trigger frame described in connection with block 304 below) from the wireless AP, where the trigger frame is configured to trigger the UE to transmit a communication from the wireless STA to the wireless AP. In one specific example, the wireless AP can indicate the propagation delay in a new format of a basic trigger frame defined for WLAN communications, or one or more fields or subfields of the basic trigger frame, such as in a new subfield in a trigger-dependent user information field of the basic trigger frame.

In some examples, in block 304, the wireless STA can receive, from the wireless AP, a trigger frame configured to trigger a transmission of a communication by the wireless STA. As described, in some examples, the trigger frame may include the indication of the propagation delay. In some examples, the wireless AP can indicate, in the trigger frame, a target start time, T1, corresponding to a time at which the wireless AP intends to receive or process a communication transmitted by the wireless STA, such as in response to the wireless STA receiving the trigger frame. For example, the wireless AP may indicate the target start time in a new trigger-dependent common information field in the basic trigger frame, or a new variant thereof, or another new or defined frame format. In some examples, the wireless AP can define or set T1≥T+SIFS, where T can represent a transmission end time of the trigger frame, and SIFS is the SIFS duration after T.

In some examples, in block 306, the wireless STA can transmit, to the wireless AP in response to the trigger frame, the communication at a time corresponding to a target start time of receipt of the communication by the wireless AP adjusted in accordance with the indication of the propagation delay, the target start time of receipt of the communication being later than the SIFS duration after an end time of transmission of the trigger frame by the wireless AP. For example, based on (or upon) reception of the trigger frame at block 304, which may be at a time T+Dᵢ, where Dᵢ is the one-way propagation delay to STA i, STA i can transmit the responding TB PPDU transmission at time (T1−Dᵢ) so the PPDU transmission arrives at the wireless AP at the advertised target start time, T1. For example, the wireless AP can select the target start time, T1, such that T1≥T+2*MAX₍ᵢ₎Dᵢ+some margin. In some examples, the wireless AP may additionally or alternatively advertise (such as in the trigger frame) a timing advance that each STA can use so that the TB PPDU receptions are aligned at the wireless AP at the target start time, T1.

Having the wireless STA transmit the communication with the timing offset described above can facilitate alignment in time of the TB PPDU transmissions from multiple wireless STAs received at the wireless AP, which may mitigate effects of a large propagation delay between the wireless AP and multiple wireless STAs, as described above. In addition, in this example, there may be no (or negligible) restriction on range, no (or negligible) expected performance degradation for a single user UL OFDMA scenario, no (or negligible) restriction on a UL OFDMA grouping and RU allocation, low or no sensitive to a position/round-trip time (RTT) accuracy (for example, accuracy within tens of meters may be acceptable). In addition, for example, interoperability may be possible due to associated signaling defined in WLAN specifications.

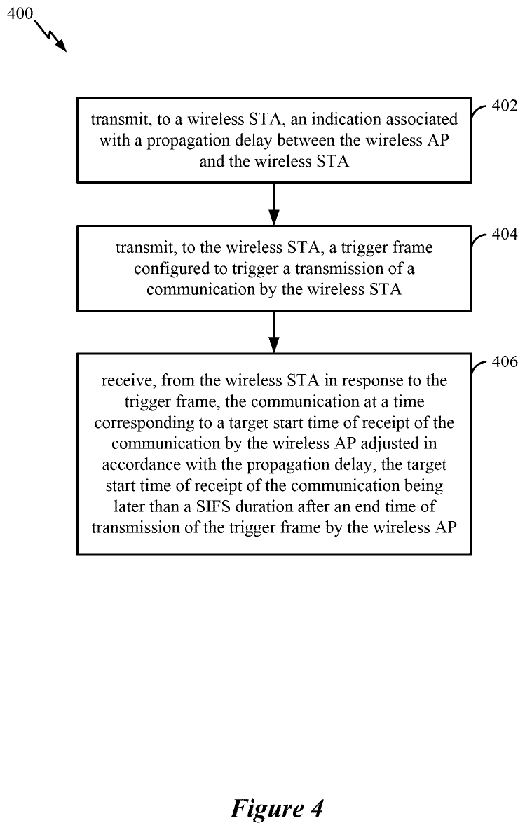

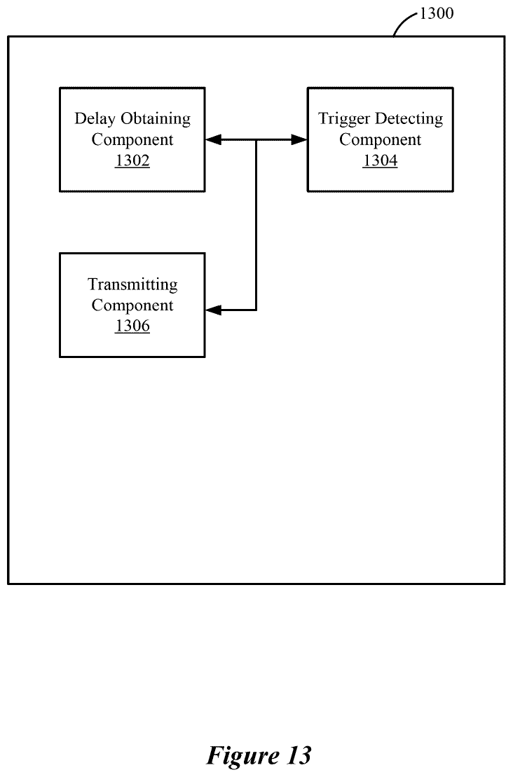

FIG. 4 shows a flowchart illustrating an example process 400 performable at a wireless AP that supports trigger-based uplink transmissions adjusted for a propagation delay between a STA and the AP according to some aspects of the present disclosure. The operations of the process 400 may be implemented by a wireless AP or its components as described herein. For example, the process 400 may be performed by a wireless communication device, such as the wireless communication device 1300 described with reference to FIG. 13, operating as or within a wireless AP. In some examples, the process 400 may be performed by a wireless AP such as one of the APs 102 described with reference to FIG. 1.

In some examples, in block 402, the wireless AP can transmit, to a wireless STA, an indication associated with a propagation delay between the wireless AP and the wireless STA. The indication can be similar to, or the same as, the indication described in reference to block 302 above. In some examples, the wireless AP can periodically estimate the propagation delay between the wireless AP and the wireless STA (for example, using a periodicity, which may be defined as a number of seconds). In another example, the wireless AP can transmit the indication to the wireless STA according to the periodicity and/or can accordingly detect a change in the propagation delay, etc. For example, the wireless AP can estimate the propagation delay using an external position or distance tracking measurement, which may be received from the wireless STA, such as a global positioning system (GPS) signal measurement performed by the wireless STA, or another tracked position of the wireless station. In another example, the wireless AP can estimate the propagation delay using an internal RTT measurement of one or more signals transmitted and/or received from the wireless STA, which may include a SU transmit-to-ACK/BA-receive turnaround time, and/or the like. In some examples, as described above, the wireless AP can transmit the indication of the propagation delay to the wireless STA in a new subfield in a trigger-dependent user information field in a basic trigger frame or variant thereof, in another frame format, and/or the like. In addition, for example, the wireless AP may estimate the propagation delays for multiple wireless STAs and/or may indicate the estimated propagation delays to the multiple wireless STAs as described.

In some examples, in block 404, the wireless AP can transmit, to a wireless STA, a trigger frame configured to trigger a transmission of a communication by the wireless STA. For example, the wireless AP can transmit the trigger frame along with an indication of a target start time, T1, at which the wireless AP expects to receive a transmission from the wireless STA, as described in reference to block 304 above. In some examples, the wireless AP can transmit the indication of the target start time, T1, in a new trigger-dependent common information field in the basic trigger frame or a new variant thereof, in another frame format, etc.

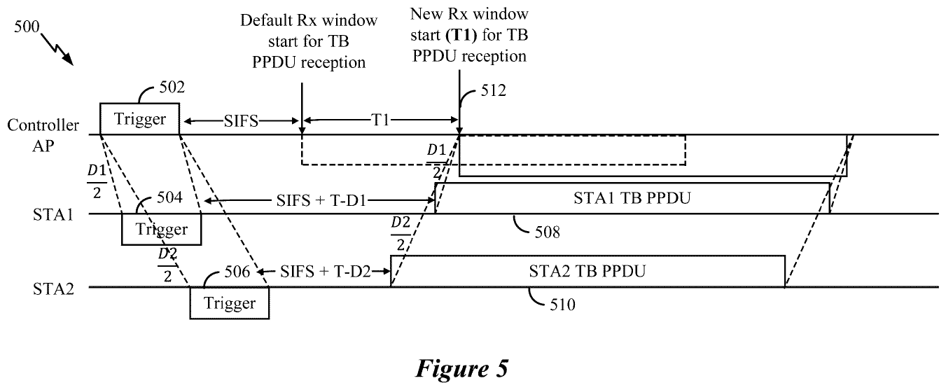

In some examples, in block 406, the wireless AP can receive, from the wireless STA in response to the trigger frame, the communication at a time corresponding to a target start time of receipt of the communication by the wireless AP adjusted in accordance with the propagation delay, the target start time of receipt of the communication being later than a SIFS duration after an end of transmission of the trigger frame by the wireless AP. For example, as described in reference to block 306 above, the wireless AP can select the target start time, T1, such that T1≥T+2*MAX₍ᵢ₎Dᵢ, or can otherwise advertise a TA for each wireless STA in its trigger frame to cause the wireless STAs to transmit the communication at a time T1−Dᵢ. In this example, the TB PPDU transmission from the wireless STA can arrive at the wireless AP at the time T1. In this regard, the reception start times of TB PPDU transmissions received from multiple wireless STAs can be substantially or nearly aligned at the wireless AP at time T1. An example is shown in FIG. 5.

FIG. 5 shows an example timeline 500 of communications between an AP and two STAs in consideration of a propagation delay between the AP and each STA according to some aspects of the present disclosure. In timeline 500, the AP can transmit a trigger frame 502, which is received by a STA1 at time

$$\frac{D 1}{2} ,$$

as shown at 504, and received by a STA2 at time

$$\frac{D 2}{2} ,$$

as shown at 506. In this example, and as described in reference to FIGS. 3 and 4 above, the AP can transmit an indication of the round-trip propagation delay D1 to the STA1 and an indication of the round-trip propagation delay D2 to the STA2. In this example, the STA1 can transmit a STA1 TB PPDU transmission to the AP at an end time of the trigger frame, T, plus the SIFS duration minus the round-trip propagation delay D1 (SIFS+T−D1), as shown at 508. In addition, in this example, the STA2 can transmit a STA2 TB PPDU transmission to the AP at an end time of the trigger frame, T, plus the SIFS duration minus the round-trip propagation delay D2 (SIFS+T−D2), as shown at 510. In this example, the AP can receive the STA1 TB PPDU transmission and the STA2 TB PPDU transmission at the similar (or aligned) time shown at 512. In another example, the AP can transmit a target start time for receiving communications from the STA1, T1, to the STA1 and the STA2, and the STAs can use this value in determining the transmit time, as described above.

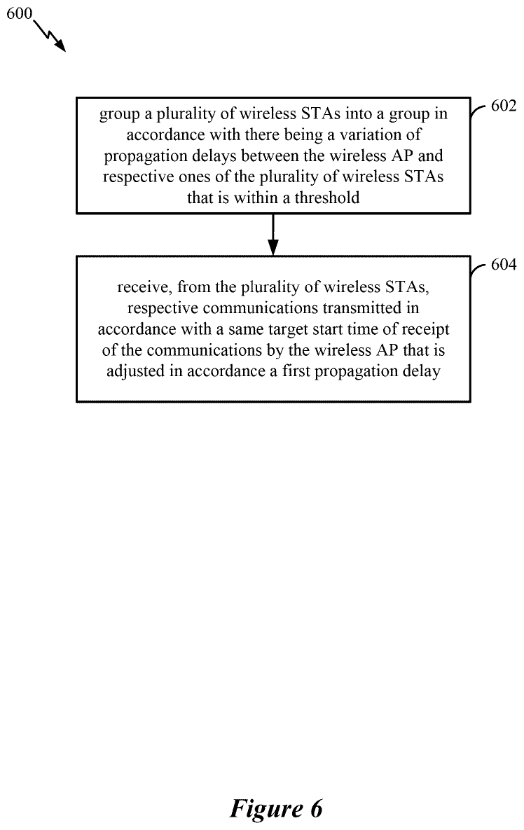

FIG. 6 shows a flowchart illustrating an example process 600 performable at an AP that supports grouping multiple STAs for communicating with the AP in consideration of propagation delays between the AP and the STAs according to some aspects of the present disclosure. The operations of the process 600 may be implemented by a wireless AP or its components as described herein. For example, the process 600 may be performed by a wireless communication device, such as the wireless communication device 1300 described with reference to FIG. 13, operating as or within a wireless AP. In some examples, the process 600 may be performed by a wireless AP such as one of the APs 102 described with reference to FIG. 1.

In some examples, in block 602, the wireless AP can group a plurality of wireless STAs into a group in accordance with there being a variation of propagation delays between the wireless AP and respective ones of the plurality of wireless STAs that is within a threshold. For example, as described in reference to block 402 above, the wireless AP can estimate the propagation delay between the wireless AP and each of the multiple wireless STAs, which may occur periodically (such as according to a few seconds periodicity) and/or may be based on, or determined using, an external position or distance tracking measurement, an internal RTT measurement, and/or the like. For example, the propagation delay may be a round-trip propagation delay measured or estimated by the wireless AP to/from each of the wireless STAs. For example, the wireless AP can group the wireless STAs based on the propagation delay to ensure the wireless STAs within each group each have a propagation delay with the wireless AP that is within a threshold. In other words, in some examples, the wireless AP can group the wireless STAs in groups based on a difference between a minimum (or shortest) propagation delay of the wireless STAs in the group and the maximum (or longest) propagation delay of the wireless STAs in the group being within the threshold.

In some examples, the wireless AP can group various UL MU STAs and select a GI such that in the scheduled MU group, one or more conditions regarding the GI may be satisfied. In some examples, the wireless AP can group the UL MU STAs and select the GI for the group such that a difference between a maximum propagation delay of the propagation delays of the scheduled STAs in the group and the minimum propagation delay of the propagation delays of the scheduled STAs in the group, plus an estimated delay spread, is less than or equal to the GI or some configurable threshold. This can allow the wireless AP to restrict the inter-STA delay spread among the scheduled STAs, and hence inter-symbol interference, as described above. Moreover, in some examples, the wireless AP can apply this grouping rule (or similar grouping rules) in addition to one or more other grouping rules, which may address other performance criteria, in grouping the wireless STAs. For example, the wireless AP may also group the wireless STAs in accordance with there being a channel correlation among the wireless STAs, a buffer stats report of the multiple STAs (for example the buffer status report indicating an amount of buffered data to transmit that is within a threshold difference among the multiple STAs), a fairness consideration or algorithm among the multiple STAs (for example to result in each of the multiple STAs having an opportunity to transmit), and/or the like.

In some examples, in block 604, the wireless AP can receive, from the plurality of wireless STAs, respective communications transmitted in accordance with a same target start time of receipt of the communications by the wireless AP that is adjusted in accordance with a first propagation delay. For example, the wireless AP can receive the respective communications in response to, or otherwise based on, transmitting a trigger frame to cause the wireless STAs to transmit communications to the wireless AP. For example, after transmitting the trigger frame at time T, the wireless AP can proceed with the TB PPDU reception from multiple wireless STAs while possibly accounting for the propagation delays between the wireless AP and the multiple wireless STAs, as described. In some examples, the first propagation delay, in accordance with which the wireless AP adjusts its target start time, can be a minimum propagation delay of the propagation delays of the wireless STAs in the group, a maximum propagation delay of the propagation delays of the wireless STAs in the group, an average propagation delay of the propagation delays of the wireless STAs in the group (such as a computed or mean average, a median average, etc.), and/or the like.

In some examples, the wireless AP can set its target start time for receiving the communications to T+SIFS+the first propagation delay (such as a minimum propagation delay of the propagation delays of the wireless STAs in the group). The wireless AP can start searching for a symbol boundary from this target start time, or may hardcode the symbol start boundary to the nominal value of the target start time, which may also include a configurable margin. In another example, the wireless AP may estimate a symbol timing of each wireless STA directly from the received TB PPDU transmissions and can accordingly adjust its target start time, or its associated receive timing window. For example, the wireless AP may use an RU-specific filter to detect the symbol boundaries of the corresponding wireless STAs based on the received TB PPDU transmissions or may use a short pilot exchange with one (or each) wireless STA before receiving the TB PPDU transmission. In some examples, the wireless AP may not attempt to decode the preamble of the TB PPDU and instead may align its receive timing window directly to the high efficiency (HE) symbol boundary of the TB PPDU to receive the TB PPDU. In some examples, the wireless AP can effectively receive the TB PPDUs from the various wireless STAs grouped as having similar propagation delays with the wireless AP. This may alleviate restriction on a range between wireless communication devices, result in no (or negligible) expected performance degradation for a one wireless STA UL OFDMA scenario, may not be sensitive to a position/RTT accuracy (accuracy within tens of meters may be acceptable), may not require hardware or WLAN specification modification, may not have an associated signaling overhead, etc.

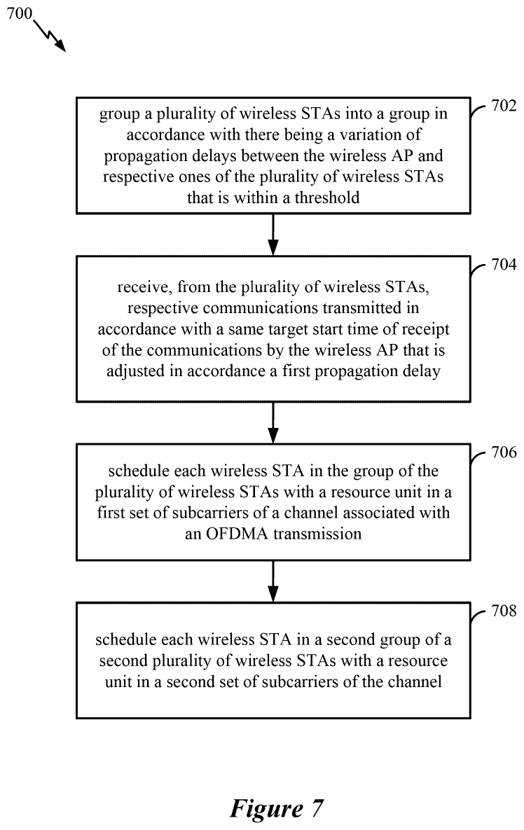

FIG. 7 shows a flowchart illustrating an example process 700 performable at an AP that supports scheduling multiple groups of wireless STAs for communicating with the AP in consideration of propagation delays between the AP and the STAs according to some aspects of the present disclosure. The operations of the process 700 may be implemented by a wireless AP or its components as described herein. For example, the process 700 may be performed by a wireless communication device, such as the wireless communication device 1300 described with reference to FIG. 13, operating as or within a wireless AP. In some examples, the process 700 may be performed by a wireless AP such as one of the APs 102 described with reference to FIG. 1.

In some examples, in block 702, the wireless AP can group a plurality of wireless STAs into a group in accordance with there being a variation of propagation delays between the wireless AP and respective ones of the plurality of wireless STAs that is within a threshold, as described in reference to block 602 above.

In some examples, in block 704, the wireless AP can receive, from the plurality of wireless STAs, respective communications transmitted in accordance with a same target start time of receipt of the communications by the wireless AP that is adjusted in accordance with a first propagation delay, as described in reference to block 604 above.

In some examples, in block 706, the wireless AP can schedule each wireless STA in the group of the plurality of wireless STAs with a RU in a first set of subcarriers of a channel associated with a OFDMA transmission. In some examples, in block 708, the wireless AP can schedule each wireless STA in a second group of the plurality of wireless STAs with a RU in a second set of subcarriers of a channel associated with a OFDMA transmission. For example, where the wireless AP operates within a certain bandwidth, such as W MHz wide bandwidth, the wireless AP can detect and decode a W MHz wide signal by dividing the W MHz into L number of contiguous frequency segments. In this example, the wireless AP can independently process each segment, where each segment is W L MHz. An example of this may include 802.11 ac 80p80 packet where the wireless AP can process a packet as two independent 80 MHz segments.

In this example, the wireless AP can schedule the users among the L frequency segments, such that for each RU i in a frequency segment l, denoted ru(l, i), the propagation delay difference can be minimized with respect to the neighboring RUs. For example, the wireless AP can schedule multiple wireless STAs with resources in the RUs such that the propagation delay between the wireless STAs occupying resources in ru(l, i) and ru(l, i+1) and the propagation delay between the wireless STAs occupying resources in ru(l, i) and ru(l, i−1) are minimized. For example, one reason for scheduling the wireless STAs in this regard can be that interference due to a signal of one wireless STA not aligned with FFT window may substantially impact the neighboring tones. In addition, as described above, the wireless AP can group the wireless STAs or set the GI such that the propagation delay difference between the wireless STAs among the frequency segments, plus an expected delay spread, can be less than or equal to the GI or a configurable threshold. In addition, as described above, the wireless AP can group the wireless STAs based on one or more other grouping rules that may address other performance criteria such as a channel correlation, BSR, fairness, etc.

Moreover, in this example, the wireless AP can exploit different reception schemes per frequency segment. For example, the wireless AP can independently set the target start time for receiving communications transmitted by the wireless STAs for each segment. In some examples, the wireless AP can set its target start time for receiving the communications for one (or each) frequency segment to T+SIFS+the first propagation delay related to the frequency segment (such as a minimum propagation delay of the propagation delays of the wireless STAs scheduled in the frequency segment). In other words, for example, the wireless AP can set its target start time for receiving the communications for a first group of wireless STAs scheduled in a first frequency segment to T+SIFS+the first propagation delay associated with the first group of wireless STAs, and the wireless AP can set its second target start time for receiving the communications for a second group of wireless STAs scheduled in a first frequency segment to T+SIFS+a second propagation delay associated with the second group of wireless STAs, etc. In addition, in this example, the wireless AP can adjust the target start time for the first group of wireless STAs in accordance with a first symbol that occurs after the target start time that is adjusted in accordance with the first propagation delay, and/or can adjust the second target start time for the second group of wireless STAs in accordance with a first symbol that occurs after the second target start time that is adjusted in accordance with the second propagation delay.

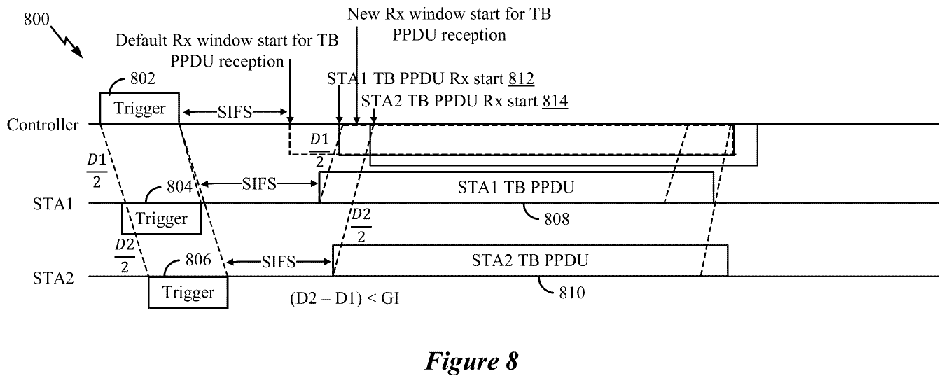

Separately adjusting the target start time for each group of wireless STAs in this regard may allow for grouping a small number of wireless STAs (for example, less than L wireless STAs) so the wireless STAs can directly benefit from independent receive processing without loss in performance compared to SU. In addition, separately adjusting the target start time for each group of wireless STAs can provide more flexibilities to RU grouping since grouping restrictions can be at a per segment level, or can provide reduced inter user interference and improved detection and decoding performance. An example is shown in FIG. 8.

FIG. 8 shows an example timeline 800 of communications between an AP and two wireless STAs by which the AP can group the STAs according to propagation delays between the AP and the STAs according to some aspects of the present disclosure. In timeline 800, the AP can transmit a trigger frame 802, which is received by the STA1 at time

$$\frac{D 1}{2} ,$$

as shown at 804, and received by the STA2 at time

$$\frac{D 2}{2} ,$$

as shown at 806. In this example, and as described in reference to FIGS. 6 and 7 above, the AP can group the STA1 and the STA2 based on determining that (D2−D1)≤GI. In this example, the STA1 can transmit a STA1 TB PPDU transmission at 808, and the STA2 can transmit a STA2 TB PPDU transmission at 810. As the STAs have propagation delay with the AP that is within a threshold difference, the AP can start a receive window for receiving the STA1 TB PPDU transmission at 812 and can start a receive window for receiving the STA2 TB PPDU transmission at 814, where the start times for receiving have a difference that is less than the GI. The AP can group the STAs to maintain the difference in the propagation delays for the STAs in a given group to be less than the GI or another threshold.

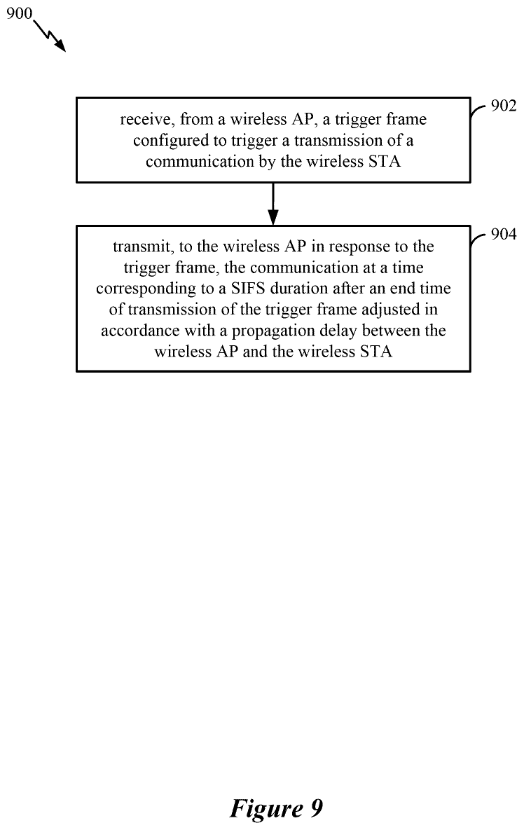

FIG. 9 shows a flowchart illustrating an example process 900 performable at a STA that supports trigger-based uplink transmissions adjusted for a propagation delay between the STA and an AP according to some aspects of the present disclosure. The operations of the process 900 may be implemented by a wireless STA or its components as described herein. For example, the process 900 may be performed by a wireless communication device, such as the wireless communication device 1200 described with reference to FIG. 12, operating as or within a wireless STA. In some examples, the process 900 may be performed by a wireless STA such as one of the STAs 104 described with reference to FIG. 1.

In some examples, in block 902, the wireless STA can receive, from the wireless AP, a trigger frame configured to trigger a transmission of a communication by the wireless STA. In some examples, in block 904, the wireless STA can transmit, to the wireless AP in response to the trigger frame, the communication at a time corresponding to a SIFS duration after an end time of transmission of the trigger frame adjusted in accordance with a propagation delay between the wireless AP and the wireless STA. In some examples, the wireless STA can periodically estimate the propagation delay from the AP (such as at a few second periodicity). For example, the wireless STA may estimate the propagation delay from the wireless AP, which may include using an external position or distance tracking measure, such as GPS, using an internal RTT measurement, as described above, and/or the like. In some examples, the wireless STA can perform the internal RTT measurement by determining a time difference between a time at which the signals are transmitted by the wireless AP and a time at which the signals are received by the wireless STA, which may include a SU transmit-to-ACK/BA-receive turnaround time.

In some examples, when the wireless STA receives the trigger frame from the wireless AP at time T+Dᵢ, as described above, where Dᵢ is the propagation delay estimated by the STA i, the STA i can transmit the TB PPDU transmission in response to the trigger frame at time T+SIFS−Dᵢ so the TB PPDU transmission arrives at the wireless AP at or near the time T+SIFS. In some examples,

$${D}_{i} \leq \frac{SIFS}{2} = 8 μs ,$$

which can correspond to a range between wireless devices of about 2.4 Km. In some examples, the wireless AP can configure a configurable SIFS duration to facilitate extending the range beyond 2.4 Km. In this example, the wireless STA can receive a configuration from the wireless AP that indicates the SIFS duration, which the wireless STA can use in computing T+SIFS−Dᵢ for transmitting the communication to the wireless AP after receiving the trigger frame. This can ensure that the reception start times of the TB PPDU transmissions from multiple STAs are substantially aligned at the wireless AP. In addition, for example, this can relax restriction on a range between wireless devices, may have no (or negligible) expected performance degradation for a single user UL OFDMA scenario, may have no (or negligible) signaling overhead, may have no (or negligible) restriction on a UL OFDMA grouping and RU allocation, may not be sensitive to a position/RTT accuracy (accuracy within tens of meters may be acceptable), etc.

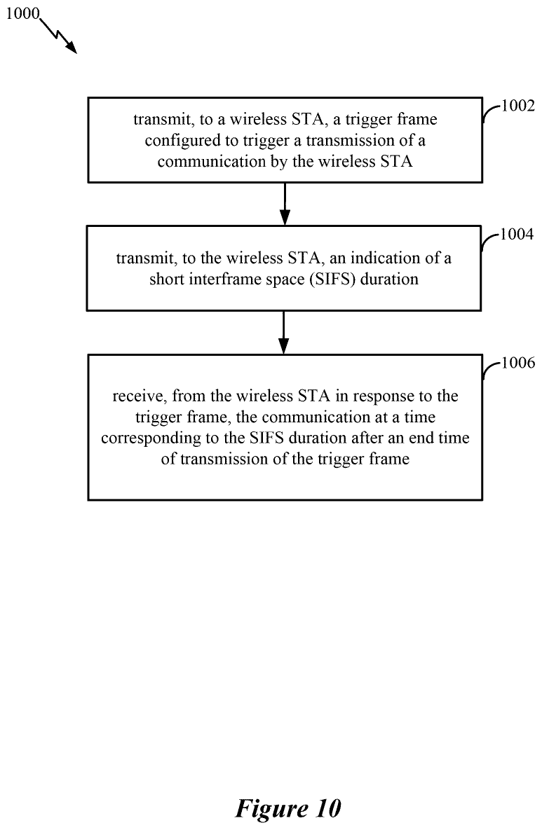

FIG. 10 shows a flowchart illustrating an example process 1000 performable at an AP that supports trigger-based uplink transmissions adjusted for a propagation delay between a STA and the AP according to some aspects of the present disclosure. The operations of the process 1000 may be implemented by a wireless AP or its components as described herein. For example, the process 1000 may be performed by a wireless communication device, such as the wireless communication device 1300 described with reference to FIG. 13, operating as or within a wireless AP. In some examples, the process 1000 may be performed by a wireless AP such as one of the APs 102 described with reference to FIG. 1.

In some examples, in block 1002, the wireless AP can transmit, to a wireless STA, a trigger frame configured to trigger a transmission of a communication by the wireless STA. In some examples, in block 1004, the wireless AP can transmit, to the wireless STA, an indication of a SIFS duration. As described, in some examples, the SIFS duration can be a configurable parameter to facilitate a range extension supported by the wireless AP. For example, the wireless AP can advertise the configurable SIFS duration in a beacon signal (for example, in a vendor-specific field in the beacon signal). The wireless STA can obtain the configurable SIFS duration, as described, and can use the configurable SIFS duration in determining a time to transmit a response TB PPDU in response to the trigger frame.

In some examples, in block 1006, the wireless AP can receive, from the wireless STA in response to the trigger frame, the communication at a time corresponding to the SIFS duration after an end time of transmission of the trigger frame adjusted in accordance with a propagation delay between the wireless AP and the wireless STA. As described, for example, the wireless STA can have adjusted a transmit time for transmitting the communication in response to the trigger frame, such as at T+SIFS−Dᵢ, so that the wireless AP receives the communication at T+SIFS, where SIFS is the configurable SIFS duration.

In some examples, in block 1004, the wireless AP can estimate, determine, or compute the configurable SIFS duration in accordance with various considerations. For example, the wireless AP can set the SIFS duration to a large static value accounting for a maximum range specification (for example, SIFS=67 μs can account for distances up to 20 Km). In another example, the wireless AP may determine the SIFS duration dynamically with some periodicity (e.g., at each beacon interval, which may be associated with past OBSS and in-BSS history).

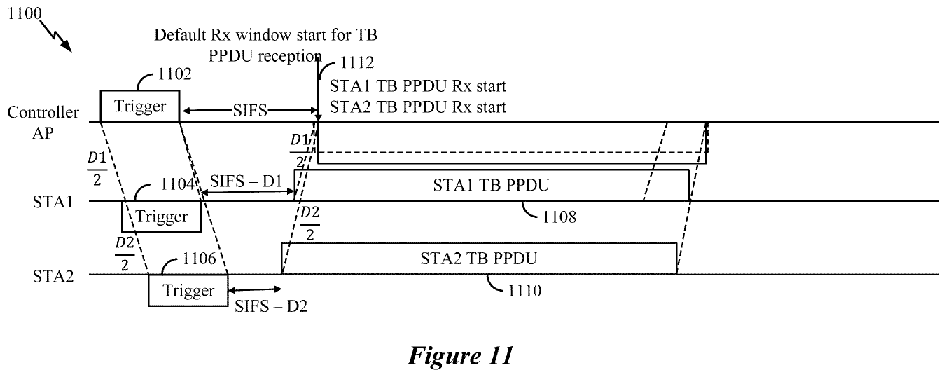

In some examples, the wireless AP may also use the configurable SIFS duration in conjunction with a restricted access window. In this example, the wireless AP may split the wireless STAs into multiple channel access groups such that the neighboring STAs (for example, the wireless STAs having within a threshold propagation delay to the wireless AP, where the threshold may be the SIFS duration) are in a same access group. In this example, the wireless AP can assign a time slice of a beacon interval to each channel access group such that within the time slice, the STAs within the corresponding group can contend for the channel. The wireless AP, for example, can advertise the restricted access window assignments in the beacons. An example is shown in FIG. 11.

FIG. 11 shows an example timeline 1100 of communications between an AP and two STAs by which each of the STAs estimates a propagation delay between itself and the AP according to some aspects of the present disclosure. In timeline 1100, the AP can transmit a trigger frame 1102, which is received by the STA1 at time

$$\frac{D 1}{2} ,$$

as shown at 1104, and received by the STA2 at time

$$\frac{D 2}{2} ,$$

as shown at 1106. In this example, and as described in reference to FIGS. 9 and 10 above, the STAs can each estimate a propagation delay to the AP can adjust a transmit time for the TB PPDU transmission based on the estimated propagation delay. In this example, the STA1 can transmit a STA1 TB PPDU transmission to the AP at a SIFS duration minus the estimated propagation delay between the STA1 and the AP, D1, from an end time of the trigger frame, as shown at 1108. In this example, the STA2 can transmit a STA2 TB PPDU transmission to the AP at a SIFS duration minus the estimated propagation delay between the STA2 and the AP, D2, from an end time of the trigger frame, as shown at 1110. In this example, the AP can receive the STA1 TB PPDU transmission and the STA2 TB PPDU transmission at the similar (or aligned) time shown at 1112.

FIG. 12 shows a block diagram of an example wireless communication device 1200 that supports trigger-based uplink transmissions adjusted for a propagation delay between a STA and an AP according to some aspects of the present disclosure. In some examples, the wireless communication device 1200 is configured or operable to perform the process 400 described with reference to FIG. 4, the process 600 described with reference to FIG. 6, the process 700 described with reference to FIG. 7, the process 1000 described with reference to FIG. 10, etc. In various examples, the wireless communication device 1200 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1200 can be a device for use in an AP, such as AP 102 described with reference to FIG. 1. In some other examples, the wireless communication device 1200 can be an AP that includes such a chip, SoC, chipset, package or device as well as multiple antennas. The wireless communication device 1200 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1200 also includes or can be coupled with an application processor which may be further coupled with another memory. In some examples, the wireless communication device 1200 further includes at least one external network interface that enables communication with a core network or backhaul network to gain access to external networks including the Internet.

The wireless communication device 1200 includes a delay indicating component 1202, a trigger transmitting component 1204, and a receiving component 1206. Portions of one or more of the components 1202, 1204, and 1206 may be implemented at least in part in hardware or firmware. For example, the receiving component 1206 may be implemented at least in part by a modem. In some examples, at least some of the components 1202, 1204, and 1206 are implemented at least in part by a processor and as software stored in a memory. For example, portions of one or more of the components 1202, 1204, or 1206 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 1200). For example, a processing system of the device 1200 may refer to a system including the various other components or subcomponents of the device 1200, such as the processor, or a transceiver, or a communications manager, or other components or combinations of components of the device 1200. The processing system of the device 1200 may interface with other components of the device 1200, and may process information received from other components (such as inputs or signals) or output information to other components. For example, a chip or modem of the device 1200 may include a processing system, a first interface to output information and a second interface to obtain information. In some implementations, the first interface may refer to an interface between the processing system of the chip or modem and a transmitter, such that the device 1200 may transmit information output from the chip or modem. In some implementations, the second interface may refer to an interface between the processing system of the chip or modem and a receiver, such that the device 1200 may obtain information or signal inputs, and the information may be passed to the processing system. A person having ordinary skill in the art will readily recognize that the first interface also may obtain information or signal inputs, and the second interface also may output information or signal outputs.

The delay indicating component 1202 is capable of, configured to, or operable to estimate and/or indicate the propagation delay between the device 1200 and a wireless STA (or other device), transmit an indication of the propagation delay, or a value of the propagation delay, as described herein. For example, the delay indicating component 1202 can transmit an indication of the propagation delay to the wireless STA (e.g., in a new subfield in a trigger-dependent user information field). In another example, the delay indicating component 1202 can estimate the propagation delay to the wireless STA (or other device) based on external position or distance tracking measures (for example, a difference in GPS position of the device 1200 and the wireless STA), based on internal RTT measurements of signals transmitted to and/or received from the wireless STA (or other device), etc.

The trigger transmitting component 1204 is capable of, configured to, or operable to transmit a trigger or trigger frame indicating to a wireless STA to transmit a communication to the device 1200.

The receiving component 1206 is capable of, configured to, or operable to receive the communication from the wireless STA, which may be based on the trigger frame, and/or may be associated with the wireless STA adjusting a transmit time, which may be based on delay indicating component 1202 or trigger transmitting component 1204 indicating the propagation delay, an associated target start time, etc. For example, the wireless STA can adjust the transmit time based on the propagation delay (or similar propagation delay determined from other devices) to facilitate a certain receive time at the device 1200 for receiving the communications from the wireless STA. In other examples, the receiving component 1206 may group wireless STAs for scheduling such that the wireless STAs within a group have within a threshold difference in propagation delay with the device 1200, as described above. In other examples, the receiving component 1206 may configure a configurable SIFS duration, as described above.

FIG. 13 shows a block diagram of an example wireless communication device 1300 that supports trigger-based uplink transmissions adjusted for a propagation delay between a STA and an AP according to some aspects of the present disclosure. In some examples, the wireless communication device 1300 is configured or operable to perform the process 300 described with reference to FIG. 3, process 900 described with reference to FIG. 9, etc. In various examples, the wireless communication device 1300 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”).

In some examples, the wireless communication device 1300 can be a device for use in a STA, such as STA 104 described with reference to FIG. 1. In some other examples, the wireless communication device 1300 can be a STA that includes such a chip, SoC, chipset, package or device as well as multiple antennas. The wireless communication device 1300 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1300 also includes or can be coupled with an application processor which may be further coupled with another memory. In some examples, the wireless communication device 1300 further includes a user interface (UI) (such as a touchscreen or keypad) and a display, which may be integrated with the UI to form a touchscreen display. In some examples, the wireless communication device 1300 may further include one or more sensors such as, for example, one or more inertial sensors, accelerometers, temperature sensors, pressure sensors, or altitude sensors.

The wireless communication device 1300 includes a delay obtaining component 1302, a trigger detecting component 1304, and a transmitting component 1306. Portions of one or more of the components 1302, 1304, and 1306 may be implemented at least in part in hardware or firmware. For example, the transmitting component 1306 may be implemented at least in part by a modem. In some examples, at least some of the components 1302, 1304, and 1306 are implemented at least in part by a processor and as software stored in a memory. For example, portions of one or more of the components 1302, 1304, or 1306 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 1300). For example, a processing system of the device 1300 may refer to a system including the various other components or subcomponents of the device 1300, such as the processor, or a transceiver, or a communications manager, or other components or combinations of components of the device 1300. The processing system of the device 1300 may interface with other components of the device 1300, and may process information received from other components (such as inputs or signals) or output information to other components. For example, a chip or modem of the device 1300 may include a processing system, a first interface to output information and a second interface to obtain information. In some implementations, the first interface may refer to an interface between the processing system of the chip or modem and a transmitter, such that the device 1300 may transmit information output from the chip or modem. In some implementations, the second interface may refer to an interface between the processing system of the chip or modem and a receiver, such that the device 1300 may obtain information or signal inputs, and the information may be passed to the processing system. A person having ordinary skill in the art will readily recognize that the first interface also may obtain information or signal inputs, and the second interface also may output information or signal outputs.

The delay obtaining component 1302 is capable of, configured to, or operable to obtain the propagation delay between the device 1300 and a wireless AP (or other device), an indication of the propagation delay, or a value of the propagation delay, as described herein. For example, the delay obtaining component 1302 can obtain an indication of the propagation delay from the wireless AP (e.g., in a new subfield in a trigger-dependent user information field). In another example, the delay obtaining component 1302 can estimate the propagation delay to the wireless AP (or other device) based on external position or distance tracking measures (for example, a difference in GPS position of the device 1300 and the wireless AP), based on internal RTT measurements of signals transmitted to and/or received from the wireless AP (or other device), etc.

The trigger detecting component 1304 is capable of, configured to, or operable to receive or otherwise detect a trigger or trigger frame indicating to transmit a communication to the wireless AP (or other device).

The transmitting component 1306 is capable of, configured to, or operable to transmit the communication to the wireless AP, which may be based on the trigger frame, and/or may be associated with adjusting a transmit time based on the propagation delay (or similar propagation delay determined from other devices) to facilitate a certain receive time at the wireless AP for receiving the communications from the device 1300 (and/or other devices).

Implementation examples are described in the following numbered clauses:

Clause 1 includes a method for wireless communication performable at a wireless station including receiving, from a wireless access point, an indication associated with a propagation delay between the wireless access point and the wireless station, receiving, from the wireless access point, a trigger frame configured to trigger a transmission of a communication by the wireless station, and transmitting, to the wireless access point in response to the trigger frame, the communication at a time corresponding to a target start time of receipt of the communication by the wireless access point adjusted in accordance with the indication of the propagation delay, the target start time of receipt of the communication being later than a short interframe space (SIFS) duration after an end time of transmission of the trigger frame by the wireless access point.

Clause 2 includes the method of Clause 1, where the indication is received in a field of the trigger frame.

Clause 3 includes the method of any of Clauses 1 or 2, where the field is a trigger-dependent user information field.

Clause 4 includes the method of any of Clauses 1 to 3 including receiving, from the wireless access point, a second indication associated with the target start time.

Clause 5 includes the method of Clause 4, where the second indication is received in a field of the trigger frame.

Clause 6 includes the method of Clause 5, where the field is a trigger-dependent common information field.

Clause 7 includes the method of any of Clauses 1 to 6 where the indication associated with the propagation delay indicates the time corresponding to the target start time adjusted by the propagation delay.

Clause 8 is a method for wireless communication performable at a wireless access point including transmitting, to a wireless station, an indication associated with a propagation delay between the wireless access point and the wireless station, transmitting, to the wireless station, a trigger frame configured to trigger a transmission of a communication by the wireless station, and receiving, from the wireless station in response to the trigger frame, the communication at a time corresponding to a target start time of receipt of the communication by the wireless access point adjusted in accordance with the propagation delay, the target start time of receipt of the communication being later than a short interframe space (SIFS) duration after an end time of transmission of the trigger frame by the wireless access point.

Clause 9 includes the method of Clause 8, where the indication is transmitted in a field of the trigger frame.

Clause 10 includes the method of Clause 9, where the field is a trigger-dependent user information field.

Clause 11 includes the method of any of Clauses 8 to 10, including transmitting, to the wireless station, a second indication associated with the target start time.

Clause 12 includes the method of Clause 11, where the second indication is transmitted in a field of the trigger frame.

Clause 13 includes the method of Clause 12, where the field is a trigger-dependent common information field.

Clause 14 includes the method of any of Clauses 8 to 13, where the indication associated with the propagation delay indicates the time corresponding to the target start time adjusted by the propagation delay.

Clause 15 includes the method of any of Clauses 8 to 14, where the propagation delay is associated with one or more of a tracked position of the wireless station or one or more round-trip time measurements for communications with the wireless station.

Clause 16 is a method for wireless communication performable at a wireless access point including grouping a plurality of wireless stations into a group in accordance with there being a variation of propagation delays between the wireless access point and respective ones of the plurality of wireless stations that is within a threshold, and receiving, from the plurality of wireless stations, respective communications transmitted in accordance with a same target start time of receipt of the communications by the wireless access point that is adjusted in accordance a first propagation delay, the first propagation delay being one of a longest one of the propagation delays, a shortest one of the propagation delays, or an average of the propagation delays.

Clause 17 includes the method of Clause 16, where the grouping of the plurality of wireless stations into the group is further in accordance with a difference between the longest one of the propagation delays and the shortest one of the propagation delays added to an estimated delay spread associated with the propagation delays being less than the threshold.

Clause 18 includes the method of Clause 17, where the threshold is a guard interval.

Clause 19 includes the method of any of Clauses 16 to 18, where the grouping of the plurality of wireless stations into the group is further in accordance with there being channel correlation among the multiple wireless stations.

Clause 20 includes the method of any of Clauses 16 to 19, where the grouping of the plurality of wireless stations into the group is further in accordance with respective buffer status reports associated with the plurality of wireless stations.

Clause 21 includes the method of any of Clauses 16 to 20, where the grouping of the plurality of wireless stations into the group is further in accordance with a fairness policy associated with the plurality of wireless stations.

Clause 22 includes the method of any of Clauses 16 to 21, where each of propagation delays associated with the plurality of wireless stations is associated with one or more of a tracked position of the respective wireless station or one or more round-trip time measurements for communications with the respective wireless station.

Clause 23 includes the method of any of Clauses 16 to 22, where the same target start time is adjusted in accordance with a short interframe space (SIFS) duration after an end time of transmission of a trigger frame by the wireless access point plus the first propagation delay.

Clause 24 includes the method of any of Clauses 16 to 23, where the same target start time is further adjusted in accordance with a first symbol that occurs after the same target start time that is adjusted in accordance with the first propagation delay.

Clause 25 includes the method of any of Clauses 16 to 24 including scheduling each wireless station in the group of the plurality of wireless stations with a resource unit in a first set of subcarriers of a channel associated with an orthogonal frequency division multiple access (OFDMA) transmission, and scheduling each wireless station in a second group of a second plurality of wireless stations with a resource unit in a second set of subcarriers of the channel, where the second group of the second plurality of wireless stations have a second variation of propagation delays between the wireless access point and respective ones of the second plurality of wireless stations that is within the threshold, and where the propagation delay of at least a first wireless station in the group of the plurality of wireless stations is different than the propagation delay of a second wireless station in the second group of the second plurality of wireless stations by a duration that exceeds the threshold.

Clause 26 includes the method of Clause 25, including receiving, from the second plurality of wireless stations, respective communications transmitted in accordance with a second same start time of receipt of the communications by the wireless access point that is adjusted in accordance with a second propagation delay, the second propagation delay being one of a longest one of the second propagation delays, a shortest one of the second propagation delays, or an average of the second propagation delays.

Clause 27 includes the method of Clause 26, where the same target start time is adjusted in accordance with a short interframe space (SIFS) duration after an end time of transmission of a trigger frame by the wireless access point plus the first propagation delay, and wherein the second same target start time is adjusted in accordance with the SIFS duration after the end time of transmission of the trigger frame by the wireless access point plus the second propagation delay.

Clause 28 is a method for wireless communication performable at a wireless station including receiving, from a wireless access point, a trigger frame configured to trigger a transmission of a communication by the wireless station, and transmitting, to the wireless access point in response to the trigger frame, the communication at a time corresponding to a short interframe space (SIFS) duration after an end time of transmission of the trigger frame adjusted in accordance with a propagation delay between the wireless access point and the wireless station.

Clause 29 includes the method of Clause 28, where the SIFS duration is configurable, the method further comprising receiving, from the wireless access point, an indication of the SIFS duration.

Clause 30 includes the method of any of Clauses 28 or 29, where the propagation delay is associated with one or more of a tracked position of the wireless station or one or more round-trip time measurements for communications with the wireless station.

Clause 31 is a method for wireless communication performable at a wireless access point including transmitting, to a wireless station, a trigger frame configured to trigger a transmission of a communication by the wireless station, transmitting, to the wireless station, an indication of a short interframe space (SIFS) duration, and receiving, from the wireless station in response to the trigger frame, the communication at a time corresponding to the short interframe space (SIFS) duration after an end time of transmission of the trigger frame.

Clause 32 is an apparatus for wireless communication including a processor, memory coupled with the processor, and instructions stored in the memory and operable, when executed by the processor, to cause the apparatus to perform any of the methods of Clauses 1 to 31.

Clause 33 is an apparatus for wireless communication including means for performing any of the methods of Clauses 1 to 31.

Clause 34 is a computer-readable medium including code executable by one or more processors for wireless communications, the code including code for performing any of the methods of Clauses 1 to 31.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A wireless communication device, comprising:
at least one memory; and
at least one processor communicatively coupled with the at least one memory, the at least one processor operable to cause the wireless communication device to:
receive, from a wireless access point, an indication associated with a propagation delay between the wireless access point and the wireless communication device;
receive, from the wireless access point, a trigger frame configured to trigger a transmission of a communication by the wireless communication device; and
transmit, to the wireless access point in response to the trigger frame, the communication at a time corresponding to a target start time of receipt of the communication by the wireless access point adjusted in accordance with the indication of the propagation delay, the target start time of receipt of the communication being later than a short interframe space (SIFS) duration after an end time of transmission of the trigger frame by the wireless access point.

2. The wireless communication device of claim 1, wherein the indication is received in a field of the trigger frame.

3. The wireless communication device of claim 2, wherein the field is a trigger-dependent user information field.

4. The wireless communication device of claim 1, wherein the at least one processor is further operable to cause the wireless communication device to receive, from the wireless access point, a second indication associated with the target start time.

5. The wireless communication device of claim 4, wherein the second indication is received in a field of the trigger frame.

6. The wireless communication device of claim 5, wherein the field is a trigger-dependent common information field.

7. The wireless communication device of claim 1, wherein the indication associated with the propagation delay indicates the time corresponding to the target start time adjusted by the propagation delay.

8. A wireless communication device, comprising:
at least one memory; and
at least one processor communicatively coupled with the at least one memory, the at least one processor operable to cause the wireless communication device to:
transmit, to a wireless station, an indication associated with a propagation delay between the wireless communication device and the wireless station;
transmit, to the wireless station, a trigger frame configured to trigger a transmission of a communication by the wireless station; and
receive, from the wireless station in response to the trigger frame, the communication at a time corresponding to a target start time of receipt of the communication by the wireless communication device adjusted in accordance with the propagation delay, the target start time of receipt of the communication being later than a short interframe space (SIF S) duration after an end time of transmission of the trigger frame by the wireless communication device.

9. The wireless communication device of claim 8, wherein the indication is transmitted in a field of the trigger frame.

10. The wireless communication device of claim 9, wherein the field is a trigger-dependent user information field.

11. The wireless communication device of claim 8, wherein the at least one processor is further operable to cause the wireless communication device to transmit, to the wireless station, a second indication associated with the target start time.

12. The wireless communication device of claim 11, wherein the second indication is transmitted in a field of the trigger frame.

13. The wireless communication device of claim 12, wherein the field is a trigger-dependent common information field.

14. The wireless communication device of claim 8, wherein the indication associated with the propagation delay indicates the time corresponding to the target start time adjusted by the propagation delay.

15. The wireless communication device of claim 8, wherein the propagation delay is associated with one or more of a tracked position of the wireless station or one or more round-trip time measurements for communications with the wireless station.

16. A method for wireless communication performable at a wireless station, comprising:
receiving, from a wireless access point, an indication associated with a propagation delay between the wireless access point and the wireless station;
receiving, from the wireless access point, a trigger frame configured to trigger a transmission of a communication by the wireless station; and
transmitting, to the wireless access point in response to the trigger frame, the communication at a time corresponding to a target start time of receipt of the communication by the wireless access point adjusted in accordance with the indication of the propagation delay, the target start time of receipt of the communication being later than a short interframe space (SIFS) duration after an end time of transmission of the trigger frame by the wireless access point.

17. The method of claim 16, wherein the indication is received in a field of the trigger frame.

18. The method of claim 17, wherein the field is a trigger-dependent user information field.

19. The method of claim 16, further comprising receiving, from the wireless access point, a second indication associated with the target start time.

20. (canceled)

21. (canceled)

22. The method of claim 16, wherein the indication associated with the propagation delay indicates the time corresponding to the target start time adjusted by the propagation delay.

23-30. (canceled)
